(19) United States
(12) Patent Application Publication
(10) Pub. No.: US 2023/0002634 A1
(43) Pub. Date: Jan. 5, 2023

(54) NOVEL BINDER COMPOSITION

(71) Applicant: BASF SE, Ludwigshafen am Rhein (DE)

(72) Inventors: Friederike FLEISCHHAKER, Ludwigshafen am Rhein (DE); Bastiaan LOHMEIJER, Ludwigshafen am Rhein (DE); Wolfgang GASCHLER, Ludwigshafen am Rhein (DE); Joost LESWIN, Ludwigshafen am Rhein (DE); Crispin AMIRI NAINI, Ludwigshafen am Rhein (DE); Andrea MISSKE, Ludwigshafen am Rhein (DE); Christoph FLECKENSTEIN, Ludwigshafen am Rhein (DE); Tobias STEINBACH, Ludwigshafen am Rhein (DE); Jochen GATTERMAYER, Ludwigshafen am Rhein (DE); Sabine EICHHORN, Ludwigshafen am Rhein (DE)

(21) Appl. No.: 17/783,669

(22) PCT Filed: Dec. 14, 2020
(86) PCT No.: PCT/EP2020/085942

§ 371 Date: Jun. 9, 2022

(30) Foreign Application Priority Data
Dec. 16, 2019 (EP) 19216428.3

(51) Int. Cl. C09D 133/08

(52) U.S. Cl. CPC C09D 133/08; C08K 2003/2241

(57) ABSTRACT

The presently claimed invention relates to use of an aqueous polymer latex as a binder or co-binder in a waterborne coating composition, wherein the aqueous polymer latex is obtained by polymerizing a monomer composition M, comprising at least one tert-butyl acrylate and/or tertbutyl methacrylate monomer, by radical emulsion polymerization.

### FIELD OF THE INVENTION

The presently claimed invention relates to the use of an aqueous polymer latex as a binder or co-binder in a waterborne coating composition, wherein the aqueous polymer latex is obtained by polymerizing a monomer composition M, comprising at least one tert-butyl acrylate and/or tert-butyl methacrylate monomer, by radical emulsion polymerization.

### BACKGROUND OF THE INVENTION

The presently claimed invention relates to the use of an aqueous polymer latex as a binder or co-binder in a waterborne coating composition, wherein the aqueous polymer latex is obtained by polymerizing a monomer composition M, comprising at least one tert-butyl acrylate and/or tert-butyl methacrylate monomer, by radical emulsion polymerization. The waterborne coating composition essentially contains a titanium dioxide pigment.

Titanium dioxide (TiO₂) is frequently used as a pigment in water-borne coating compositions, such as latex paints. Besides whiteness, TiO₂ provides opacity or hiding power to the coating, which means that the coating is opaque and conceals an undersurface or substrate surface to which the coating is applied. The opacifying capacity or hiding power of such a coating or paint is a measure of the coating's ability to conceal a surface to which the coating is applied.

It was found that the opacifying capacity is a function of the spacing between the particles of opacifying pigment in the dried applied coating. The opacifying capacity of a coating is maximized when the light scattering capability of the opacifying pigment, namely TiO₂, is maximized. Maxi-mum light scattering efficiency occurs when the TiO₂ pigment particles have a certain spacing, so that the light scattering capability of each particle does not interfere with the light scattering capability of its neighboring particles. This condition may occur in coatings containing sufficiently low levels of TiO₂ such that the individual TiO₂ particles are isolated from each other. The coatings containing such low levels of TiO₂, however, do not provide sufficient whiteness and hiding at typical dried coating thicknesses. Achieving the desired levels of hiding and whiteness typically requires higher levels of TiO₂. At these higher levels, a statistical distribution of TiO₂ particles occurs, which results in at least some of the TiO₂ particles being in such close proximity to one another that there is a loss of light scattering efficiency due to crowding of the opacifying pigment particles. In short, the efficacy of the TiO₂ pigment as a hiding or opacifying pigment is reduced, when the TiO₂ particles are not homogeneously dispersed in the coating composition. In fact, TiO₂ particles tend to agglomerate upon film formation and drying. It has been suggested that the opacifying capacity of a coating can be improved by employing a polymer latex binder that promotes the homogeneity of the TiO₂ particle distribution and that promotes the interaction between binder and pigments.

EP 1 398 333 A1 discloses that the spacing of TiO₂ pigment particles and its resultant efficiency can be improved by employing a multistage polymer latex comprising a first polymer having polymerized units of multi-ethylenically unsaturated monomers and at least one pendant absorbing group selected from phosphorous acid groups, phosphorous acid full-ester groups, polyacid side chains, and a second polymer which is essentially free of such pendant absorbing groups. In order to achieve acceptable hiding power, the polymer dispersions of EP 1 398 333 A1 require expensive phosphorous containing monomers. Moreover, the coating formulations are not always stable and tend to flocculate resulting in the formation of grit in the coatings.

EP 2 426 155 A1 discloses an aqueous multistage polymer dispersion containing polymerized units of phosphorous-containing acid monomers. The polymer dispersions are prepared by emulsion polymerization, where the phosphor containing acid monomers are added pulse-wise at an early stage of the emulsion polymerization. The multistage polymer dispersions are capable of absorbing TiO₂ pigment particles and used for preparing so-called pre-composites of the TiO₂ pigment and the aqueous multistage polymer dispersion. These pre-composites can be used in water-borne paints. The multistage polymer dispersions are suggested to achieve improved hiding power at acceptable scrub resistance and grit formation.

WO 2013/116318 A1 discloses a process for preparing aqueous multistage polymer dispersions containing polymerized units of phosphor containing acid monomers, polymerized units of a carboxylic acid or sulfur acid monomer and polymerized units of a multi-ethylenically unsaturated monomer. The process is performed as an emulsion polymerization of a monomer emulsion in a preformed polymer dispersion, which comprises the polymerized units of phosphor containing acid monomers, polymerized units of a carboxylic acid or sulfur acid monomer and polymerized units of a multi-ethylenically unsaturated monomer. Based on the total polymer, the majority of phosphor containing acid monomers and polymerized units of a multi-ethylenically unsaturated monomer are contained in the preformed polymer dispersion. The polymer dispersions of WO 2013/116318 A1 are used for preparing pre-composites of the TiO₂ pigment particles and should provide improved compatibility with TiO₂ pigment particles and reduced grit formation.

According to WO 2013/040040 A1 grit formation in paints, which contain pre-composites of the TiO₂ pigments and polymer latices, can be reduced, if the pre-composites of the TiO₂ pigment are prepared by a two-step process, wherein the first step an aqueous slurry of a TiO₂ pigment is contacted with an absorbing polymer latex, as described in EP 1 398 333 A1 or EP 2 426 155 A1, at a high pH in order to inhibit interaction between the TiO₂ pigment and the absorbing polymer latex particles and subsequently in a second step the pH is lowered to promote interaction between the TiO₂ pigment and the absorbing polymer latex particles. According to EP 2692752 A1 grit formation in paints, which contain pre-composites of the TiO₂ pigments and polymer latices and associative thickeners, can be reduced, if the TiO₂ pigment particles contain a water-soluble dispersant comprising structural units of a sulfonic acid monomer adsorbed on the surface of the pigment particles. This method suffers from the use of specific dispersants, which are not readily commercially available. The synthesis of the dispersants requires multiple solvents and specialty monomers.

The means suggested by prior art for improving the hiding or opacifying efficacy of the TiO₂ pigments are not satisfactory, as either the absorbing polymer dispersion requires expensive phosphorous containing monomers for achieving acceptable hiding or opacifying efficacy and flocculation stability or require expensive dispersants or tedious methods of preparing the TiO₂ pigment/polymer pre-composites.

Thus, it is an object of the presently claimed invention to provide an aqueous polymer dispersion, which is capable of promoting a homogeneous distribution of the TiO₂ pigments and which promotes the interaction between binder and pigments. The aqueous polymer dispersions should not require expensive phosphor containing monomers in order to achieve a good hiding/opacifying efficacy. Moreover, the aqueous polymer dispersions should provide for a good stability of the coating compositions and do not tend to form grit.

### SUMMARY OF THE INVENTION

Surprisingly, it was found that the use of an aqueous polymer latex as a binder or co-binder in a waterborne coating composition, wherein the aqueous polymer latex is obtained by polymerizing a monomer composition M, comprising at least one tert-butyl acrylate and/or tert-butyl methacrylate monomer, by radical emulsion polymerization lead to a good hiding power/opacifying efficacy.

Accordingly, the first aspect of the presently claimed invention is directed to the use of an aqueous polymer latex as a binder or co-binder in a waterborne coating composition, which contains a titanium dioxide pigment, wherein the aqueous polymer latex is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.

The second aspect of the presently claimed invention is directed to an aqueous coating composition comprising:
i) at least one aqueous polymer latex as defined as in first aspects; and
ii) a titanium dioxide pigment.

The third aspect of the presently claimed invention is directed to an aqueous polymer latex which is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangea-ble under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of sec-onds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment in’ various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In an embodiment, the presently claimed invention is directed to the use of an aqueous polymer latex which is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;
   wherein the wt. % are in each case based on the total amount of the monomer composition M; more preferably the use of an aqueous polymer latex which is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.
   wherein the wt. % are in each case based on the total amount of the monomer composition M; even more preferably the use of an aqueous polymer latex which is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.
   wherein the wt. % are in each case based on the total amount of the monomer composition M; most preferably the use of an aqueous polymer latex which is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;
   wherein the wt. % are in each case based on the total amount of the monomer composition M; and in particular the use of an aqueous polymer latex which is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤2.0 wt. % of at least one mono-ethylenically unsaturated carboxylic acid having 3 to 6 carbon atoms;
d) ≥0.1 wt. % to ≤2.0 wt. % acrylamide and/or meth acrylamide derivatives;
   wherein the wt. % are in each case based on the total amount of the monomer composition M.

In another preferred embodiment, the monomer a) and b) together in the range of 90.0 to 99.8 wt. %, based on the total weight of the monomers together, preferably the monomer a) and b) together in the range of 90.0 to 99.5 wt. %, based on the total weight of the monomers together, more preferably the monomer a) and b) together in the range of 92.0 to 99.5 wt. %, based on the total weight of the monomers together, most preferably the monomer a) and b) together in the range of 92.0 to 99.0 wt. %, based on the total weight of the monomers together and in particular preferably the monomer a) and b) together in the range of 92.0 to 98.0 wt. %, based on the total weight of the monomers together.

In another preferred embodiment, the mono-ethylenically unsaturated carboxylic acid c) having 3 to 6 carbon atoms is selected from the group consisting of acrylic acid, methacrylic acid, maleic acid, half methyl ester of maleic acid, half ethyl ester of maleic acid, citraconic acid, half methyl ester of citraconic acid, itaconic acid, half methyl ester of itaconic acid, 3-pentenoic acid, 2-bu-tenoic acid, fumaric acid, half methyl ester of fumaric acid, half ethyl ester of fumaric acid, halogenated acrylic acids and halogenated methacrylic acids.

In another preferred embodiment, the monomer d) is selected from the group consisting of acrylamide, and meth acrylamide derivatives.

In another preferred embodiment, the meth acrylamide derivatives are selected from the group consisting of N-methyl acrylamide, N-ethyl acrylamide, N-propyl acrylamide, N-isopropyl acrylamide, N-butyl acrylamide, N-methyl meth acrylamide, N-ethyl meth acrylamide, N-propyl meth acrylamide, N-isopropyl meth acrylamide and N-butyl meth acrylamide; and most preferably acrylamide and N-methyl acrylamide.

In another preferred embodiment, the non-ionic monomer e) is selected from the group consisting of cross-linking monomers such as divinylbenzene, ethylene glycol dimethacrylate or epoxy- or N-methylol functional monomers such as glycidyl acrylate, glycidyl methacrylate, N-methylo-lacrylamide, N-methylolmeth acrylamide derivatives. Further non-ionic monomers are monomers with hydroxy-, amino-, acetoacetoxy-, urea- or siloxane groups such as hydroxyethyl acrylate, hydroxyethyl methacrylate, dimethylaminoethyl methacrylate, acetoxyethyl methacrylate, meth-acryloxypropyltrimethoxysilane, ureido methacrylate

In another preferred embodiment, the mono-ethylenically unsaturated carboxylic acid having 3 to 6 carbon atoms, the component c), is present in an amount in the range of ≥0.1 wt. % to ≤3.0 wt. %; morepreferably the mono-ethylenically unsaturated carboxylic acid having 3 to 6 carbon atoms is present in an amount in the range of ≥0.5 wt. % to ≤3.0 wt. %; and in particular the mono-ethylenically unsaturated carboxylic acid having 3 to 6 carbon atoms is present in an amount in the range of ≥0.5 wt. % to ≤2.0 wt. %.

In another preferred embodiment, the component d), the mono-ethylenically unsaturated carboxylic acid having 3 to 6 carbon atoms is present in an amount in the range of ≥0.1 wt. % to ≤3.0 wt. %; more preferably the mono-ethylenically unsaturated carboxylic acid having 3 to 6 carbon atoms is present in an amount in the range of ≥0.5 wt. % to ≤3.0 wt. %; and in preferably the mono-ethylenically unsaturated carboxylic acid having 3 to 6 carbon atoms is present in an amount in the range of ≥0.5 wt. % to ≤2.0 wt. %.

In another preferred embodiment, the monomer composition M comprises 0.1 to 20 wt. % of at least one non-ionic monomer e), which is different from monomers a) to d); more preferably 0.1 to 15 wt. % of at least one non-ionic monomer e), which is different from monomers a) to d); most preferably 0.1 to 10 wt. % of at least one non-ionic monomer e), which is different from monomers a) to d); and in particular 1 to 10 wt. % of at least one non-ionic monomer e), which is different from monomers a) to d).

In another preferred embodiment, the monomer composition M comprises,

a) ≥40.0 wt. % to ≤79 wt. % of t-butyl acrylate or t-butyl methacrylate;
b) ≥20 wt. % to ≤59 wt. % of n-butyl acrylate;
c) ≥0.5 wt. % to ≤1.5 wt. % of acrylic acid; and
d) ≥0.5 wt. % to ≤1.5 wt. % acrylamide.

In another preferred embodiment, the aqueous polymer latex shows a Z average particle diameter in the range from ≥10 nm to ≤500 nm, as determined by dynamic light scattering; most preferably the aqueous polymer latex shows a Z average particle diameter in the range from ≥30 nm to ≤400 nm, as determined by dynamic light scattering and in particular preferably the aqueous polymer latex shows a Z average particle diameter in the range from ≥40 nm to ≤300 nm, as determined by dynamic light scattering.

In an embodiment, the presently claimed invention is directed to an aqueous polymer latex obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;
   more preferably the aqueous polymer latex is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;
   wherein the wt. % are in each case based on the total amount of the monomer composition M; even more preferably the aqueous polymer latex is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;
   wherein the wt. % are in each case based on the total amount of the monomer composition M; most preferably the aqueous polymer latex is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤2.0 wt. % of at least one mono-ethylenically unsaturated carboxylic acid having 3 to 6 carbon atoms;
d) ≥0.1 wt. % to ≤2.0 wt. % acrylamide and/or meth acrylamide derivatives;
   wherein the wt. % are in each case based on the total amount of the monomer composition M; and in particular the aqueous polymer latex is obtained by polymerizing a monomer composition M by radical emulsion polymerization, wherein the monomer composition M comprises:
a) ≥40.0 wt. % to ≤69.8 wt. % of t-butyl acrylate or t-butyl methacrylate;
b) ≥30 wt. % to ≤59.8 wt. % of n-butyl acrylate,
c) ≥0.1 wt. % to ≤2.0 wt. % of at least one mono-ethylenically unsaturated carboxylic acid having 3 to 6 carbon atoms;
d) ≥0.1 wt. % to ≤2.0 wt. % acrylamide and/or meth acrylamide derivatives;
   wherein the wt. % are in each case based on the total amount of the monomer composition M.

In another preferred embodiment, the aqueous polymer latex is obtained by polymerizing a monomer composition M by radical emulsion polymerization, wherein the monomer composition M comprises:
a) ≥40.0 wt. % to ≤79.7 wt. % of t-butyl acrylate or t-butyl methacrylate;
b) ≥20 wt. % to ≤59.7 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives; and
e) ≥0.1 wt. % to ≤10 wt. % of at least one non-ionic monomer, which is different from monomers a) to d);
   wherein the wt. % are in each case based on the total amount of the monomer composition M.

In another preferred embodiment, the process for the preparation of the polymer latex is performed according to the well-known processes of radical emulsion polymerisation technology. The conditions required for the performance of the free-radical emulsion polymerization of the monomers M are sufficiently familiar to those skilled in the art, for example from the prior art cited at the outset and from “Emulsions polymerisation” [Emulsion Polymerization] in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dis-persionen synthetischer Hochpolymere [Dispersions of Synthetic High Polymers], F. Holscher, Springer-Verlag, Berlin (1969)].

In another preferred embodiment, the free-radically initiated aqueous emulsion polymerization is triggered by means of a free-radical polymerization initiator (free-radical initiator). These are in principle peroxides, azo compounds and the redox initiator systems.

In another preferred embodiment, the peroxides are selected from the group consisting of inorganic peroxides and organic peroxides.

In another preferred embodiment, the inorganic peroxide is selected from the group consisting of hydrogen peroxide and persulfates, such as the mono- or di-alkali metal or ammonium salts of persulfuric acid, for example the mono- and disodium, potassium or ammonium salts.

In another preferred embodiment, the organic peroxide is selected from the group consisting alkyl hydroperoxides, for example tert-butyl hydroperoxide, p-menthyl hydroperoxide or cumyl hydroperoxide, and dialkyl or diaryl peroxides, such as di-tert-butyl or di-cumyl peroxide.

In another preferred embodiment, the azo compound is selected from the group consisting 2,2′-azobis(isobutyronitrile), 2,2′-azobis(2,4-dimethylvaleronitrile) and 2,2′-azobis(amidinopropyl) di-hydrochloride (AIBA, corresponds to V-50 from Wako Chemicals).

In another preferred embodiment, the suitable oxidizing agents for redox initiator systems are essentially the peroxides specified above. Corresponding reducing agents which may be used are sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylat.es, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols, such as dihydroxymaleic acid, benzoin and/or ascorbic acid, and reducing saccharides, such as sorbose, glucose, fructose and/or dihydroxyacetone.

In another preferred embodiment, the free-radical initiators are inorganic peroxides, especially persulfates, and redox initiator systems.

In another preferred embodiment, the amount of free-radical initiator for the emulsion polymerization M is initially charged in the polymerization vessel completely. However, it is also possible to charge none of or merely a portion of the free-radical initiator, e.g. not more than 40% by weight, especially not more than 30% by weight, based on the total amount of the free-radical initiator required in the aqueous polymerization medium and then, under polymerization conditions, during the free-radical emulsion polymerization of the monomers M to add the entire amount or any remaining residual amount, according to the consumption, batchwise in one or more portions or continuously with constant or varying flow rates.

In another preferred embodiment, the free-radical aqueous emulsion polymerization of the invention is conducted at temperatures in the range from 0 to 170° C.; more preferably in the range from 50 to 120° C., most preferably in the range from 60 to 120° C. and in particularly the free-radical aqueous emulsion polymerization of the invention is conducted at temperatures in the range from 70 to 110° C.

In another preferred embodiment, the free-radical aqueous emulsion polymerization is conducted at a pressure of less than, equal to or greater than 1 atm.

In another preferred embodiment, the polymerization is conducted in the presence of a chain transfer agent. The chain transfer agents are selected from the group consisting of aliphatic and/or araliphatic halogen compounds, for example n-butyl chloride, n-butyl bromide, n-butyl iodide, methylene chloride, ethylene dichloride, chloroform, bromoform, bromotrichloromethane, dibro-modichloromethane, carbon tetrachloride, carbon tetrabromide, benzyl chloride, benzyl bromide; organic thio compounds such as primary, secondary or tertiary aliphatic thiols, for example ethan-ethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and the isomeric compounds thereof, n-octanethiol and the isomeric compounds thereof, n-nonanethiol and the isomeric compounds thereof, n-decanethiol and the isomeric compounds thereof, n-undecanethiol and the isomeric compounds thereof, n-dodecanethiol and the isomeric compounds thereof, n-tridecanethiol and isomeric compounds thereof, substituted thiols, for example 2-hydroxyethanethiol, aromatic thiols such as benzeneth-iol, ortho-, meta- or para-methylbenzenethiol, alkylesters of mercaptoacetic acid (thioglycolic acid) such as 2-ethylhexyl thioglycolate, alkylesters of mercaptopropionic acid such as octyl mercapto propionate, and also further sulfur compounds described in Polymer Handbook, 3rd edition, 1989, J. Brandrup and E. H. Immergut, John Wiley & Sons, section II, pages 133 to 141, and aliphatic and/or aromatic aldehydes such as acetaldehyde, propionaldehyde and/or benzaldehyde, unsaturated fatty acids such as oleic acid, dienes having nonconjugated double bonds, such as divinylmethane or vinylcyclohexane, or hydrocarbons having readily abstractable hydrogen atoms, for example toluene.

In another preferred embodiment, the total amount of chain transfer agents used in the process of the presently claimed invention does not exceed 1% by weight, based on the total amount of monomers M.

In another preferred embodiment, the polymerization is conducted in presence of a surfactant.

In another preferred embodiment, the surfactant is selected from emulsifiers and protective colloids. The protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

In another preferred embodiment, the anionic surfactants usually bear at least one anionic group, which is selected from phosphate, phosphonate, sulfate and sulfonate groups. The anionic surfactants, which bear at least one anionic group, are typically used in the form of their alkali metal salts, especially of their sodium salts or in the form of their ammonium salts.

In another preferred embodiment, the anionic surfactants are anionic emulsifiers, in particular those, which bear at least one sulfate or sulfonate group. Likewise, anionic emulsifiers, which bear at least one phosphate or phosphonate group may be used, either as sole anionic emulsifiers or in combination with one or more anionic emulsifiers, which bear at least one sulfate or sulfonate group. Examples of anionic emulsifiers, which bear at least one sulfate or sulfonate group, are, for example, the salts, especially the alkali metal and ammonium salts, of alkyl sulfates, especially of C₈-C₂₂-alkyl sulfates, the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40, the salts, especially the alkali metal and ammonium salts, of sulfuric monoesters of ethoxylated alkylphenols, especially of sulfuric monoesters of ethoxylated C₄-C₁₈-alkylphenols (EO level preferably 3 to 40), the salts, especially the alkali metal and ammonium salts, of alkylsulfonic acids, especially of C₈-C₂₂-alkylsulfonic acids, the salts, especially the alkali metal and ammonium salts, of dialkyl esters, especially di-C₁-C₁₈-alkyl esters of sulfosuccinic acid, the salts, especially the alkali metal and ammonium salts, of alkylbenzenesulfonic acids, especially of C₄-C₂₂-alkylbenzenesulfonic acids, and—the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The examples are U.S. Pat. No. 4,269,749, and Dowfax® 2A1 (Dow Chemical Company).

In another preferred embodiment, the anionic surfactants are anionic emulsifiers, which are selected from the following groups:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of sulfuric monoesters of ethoxylated alkylphenols, especially of sulfuric monoesters of ethoxylated C₄-C₁₈-alkylphenols (EO level preferably 3 to 40), of alkylbenzenesulfonic acids, especially of C₄-C₂₂-alkylbenzenesulfonic acids, and
mono- or disulfonated, alkyl-substituted diphenyl ethers, for example of bis(phenylsulfonic acid) ethers bearing a C₄-C₂₄-alkyl group on one or both aromatic rings.

Examples of anionic emulsifies, which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of phosphoric monoesters of ethoxylated alkylphenols, especially phosphoric monoesters of ethoxylated C₄-C₁₈-alkylphenols (EO level preferably 3 to 40),
the salts, especially the alkali metal and ammonium salts, of alkylphosphonic acids, especially C₈-C₂₂-alkylphosphonic acids, and
the salts, especially the alkali metal and ammonium salts, of alkylbenzenephosphonic acids, especially C₄-C₂₂-alkylbenzenephosphonic acids.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

In another preferred embodiment, the surfactant comprises at least one anionic emulsifier, which bears at least one sulfate or sulfonate group. The at least one anionic emulsifier, which bears at least one sulfate or sulfonate group, may be the sole type of anionic emulsifiers. However, mixtures of at least one anionic emulsifier, which bears at least one sulfate or sulfonate group, and at least one anionic emulsifier, which bears at least one phosphate or phosphonate group, may also be used. In such mixtures, the amount of the at least one anionic emulsifier, which bears at least one sulfate or sulfonate group, is preferably at least 50% by weight, based on the total weight of anionic surfactants used in the process of the present invention. In particular, the amount of anionic emulsifiers, which bear at least one phosphate or phosphonate group does not exceed 20% by weight, based on the total weight of anionic surfactants used in the process of the present invention.

In another preferred embodiment, the surfactant may also comprise one or more nonionic sur-face-active substances, which are especially selected from nonionic emulsifiers. Suitable nonionic emulsifiers are e.g. araliphatic or aliphatic nonionic emulsifiers, for example ethoxylated mono-, di- and trialkylphenols (EO level 3 to 50, alkylchain: C₄-C₁₀), ethoxylates of long-chain alcohols (EO level: 3 to 100, alkyl chain: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols (alkyl chain C₁-C₃₀, mean ethoxylation level 5 to 100) and, among these, particular preference to those having a C₁₂-C₂₀ alkyl chain and a mean ethoxylation level of 5 to 20, and also to ethoxylated monoalkylphenols.

In another preferred embodiment, the surfactants used in the process of the present invention comprise less than 60% by weight, especially not more than 50% by weight, of nonionic surfactants, based on the total amount of surfactants used in the process of the present invention

In another embodiment of the invention, the surfactants used in the process of the present invention comprise at least one anionic surfactant and at least one nonionic surfactant, the ratio of anionic surfactants to non-ionic surfactants being usually in the range form 0.5:1 to 10:1, in particular from 1:1 to 5:1.

In another preferred embodiment, the surfactant/surfactants will be used in such an amount that the amount of surfactant/surfactants is in the range from 0.2% to 5% by weight, especially in the range from 0.5% to 3% by weight, based on the monomers M to be polymerized. In another preferred embodiment, the aqueous reaction medium in polymerization may in principle also comprise minor amounts 5% by weight) of water-soluble organic solvents, for example methanol, ethanol, isopropanol, butanols, pentanols, but also acetone, etc. Preferably, however, the process of the invention is conducted in the absence of such solvents.

In another preferred embodiment, the aqueous polymer dispersions obtained have polymer solids contents in the range from 10% to 70% by weight, preferably 20% to 65% by weight, more preferably 30% to 60% by weight, and most preferably 40% to 60% by weight, based in each case on the total weight of the aqueous polymer dispersion.

In an embodiment, presently claimed invention is directed to an aqueous coating composition comprising:
i) at least one aqueous polymer latex as defined above; and
ii) a titanium dioxide pigment.

In another preferred embodiment, the weight ratio of the polymer to the titanium dioxide pigment is in the range of ≥0.1:5.0 to ≤5.0:0.1; more preferably the weight ratio of the polymer to the titanium dioxide pigment is in the range of ≥0.5:5.0 to ≤5.0:0.5; even more preferably the weight ratio of the polymer to the titanium dioxide pigment is in the range of ≥1.0:5.0 to ≤5.0:1.0; most preferably more preferably the weight ratio of the polymer to the titanium dioxide pigment is in the range of ≥2.0:5.0 to ≤5.0:2.0; and in particular more preferably the weight ratio of the polymer to the titanium dioxide pigment is in the range of ≥1.0:3.0 to ≤3.0:1.0.

In another preferred embodiment, the titanium dioxide pigment has an average primary particle size in the range of ≥0.1 μm to ≤0.5 μm, as determined by light scattering or by electron micros-copy.

In another preferred embodiment, the aqueous coating composition further comprises at least one additive selected from the group consisting of thickeners, defoamers, levelling agents, bio-cides, dispersants, fillers and coalescing agents.

In another preferred embodiment, the aqueous coating composition can be simply prepared by mixing TiO₂ pigment powder or an aqueous slurry or paste of TiO₂ pigment with the aqueous polymer latex of the invention, preferably by applying shear to the mixture, e.g. by using a dissolver conventionally used for preparing water-borne paints. It will also be possible to prepare an aqueous slurry or paste of TiO₂ pigment and the aqueous polymer latex of the invention, which is then incorporated into or mixed with further polymer latex of the invention or with any other polymer latex binder.

In another preferred embodiment, the aqueous dispersion of the polymer composite may also be prepared by incorporating the aqueous polymer latex of the invention as a binder or co-binder in an aqueous base formulation of a paint, which already contains a TiO₂ pigment, e.g. by mixing the aqueous polymer latex of the invention with a pigment formulation that already contains further additives conventionally used in the paint formulation.

In another preferred embodiment, in order to stabilize the TiO₂ pigment particles in the aqueous pigment slurry or paste, the mixing may optionally be performed in the presence of additives conventionally used in aqueous pigment slurries or pigment pastes, such as dispersants. Suitable dispersants include but are not limited to, for example, polyphosphates such as sodium polyphosphates, potassium polyphosphates or ammonium polyphosphates, alkali metal salts and ammonium salts of acrylic acid homo- or copolymers or maleic anhydride polymers, polyphosphonates, such as sodium 1-hydroxyethane-1,1-diphosphonate, and naphthalenesulfonic salts, especially the sodium salts thereof.

In another preferred embodiment, the polymer concentration in aqueous polymer latex used for preparing the aqueous dispersion of the polymer composite is generally in the range from 10% to 70% by weight, preferably 20% to 65% by weight and most preferably 30% to 60% by weight, based in each case on the total weight of the aqueous polymer latex. The titanium dioxide pigment used for preparing the aqueous dispersion of the polymer composite may any TiO₂ pigment conventionally used in coating compositions, in particular in aqueous coating compositions. Frequently, a TiO₂ pigment is used wherein the TiO₂ particles are preferably in the rutile form. In another preferred embodiment the TiO₂ particles can also be coated e.g. with silica and/or alu-mina.

In another preferred embodiment, the fillers are selected from the group consisting of aluminosil-icates such as feldspars, silicates such as kaolin, talc, mica and magnesite; alkaline earth metal carbonates such as calcium carbonate in the form of calcite or chalk, magnesium carbonate and dolomite; alkaline earth metal sulfates such as calcium sulfate, silicon dioxide, etc. In the coating compositions of the invention, finely divided fillers are naturally preferred. The fillers may be used in the form of individual components. In practice, however, filler mixtures have been found to be particularly useful, for example calcium carbonate/kaolin, calcium carbonate/talc. Gloss paints generally comprise only small amounts of very finely divided fillers, or do not comprise any fillers. Fillers also include flatting agents which significantly impair the gloss as desired. Flatting agents are generally transparent and may be either organic or inorganic. Examples of flatting agents are inorganic silicates, for example the Syloid® brands from W. R. Grace & Company and the Ace-matt® brands from Evonik GmbH. Organic flatting agents are obtainable, for example, from BYK-Chemie GmbH under the Ceraflour® brands and the Ceramat® brands, and from Deuteron GmbH under the Deuteron MK® brand.

The proportion of the pigments and fillers in coating compositions can be described in a manner known per se via the pigment volume concentration (PVC). The PVC describes the ratio of the volume of pigments (VP) and fillers (VF) relative to the total volume, consisting of the volumes of binder (VB), pigments (VP) and fillers (VF) in a dried coating film in percent:

PVC=(V_{P}+V_{F})×100/(V_{P}+V_{F}+V_{B}).

In another preferred embodiment, the wetting agents are selected from the group consisting of sodium polyphosphates, potassium polyphosphates or ammonium polyphosphates, alkali metal salts and ammonium salts of acrylic acid copolymers or maleic anhydride copolymers, polyphosphonates, such as sodium 1-hydroxyethane-1,1-diphosphonate, and naphthalenesulfonic salts, especially the sodium salts thereof.

The presently claimed invention is associated with at least one of the following advantages:
1. The presently claimed invention provides a novel aqueous polymer latex as a binder or co-binder in a waterborne coating composition containing TiO₂ pigment particles.
2. The aqueous polymer dispersion of the presently claimed invention promotes a homogeneous distribution of the TiO₂ pigments in the coating. The aqueous polymer dispersion of the presently claimed invention also promotes the interaction between binder and pigments.
3. The aqueous polymer dispersion of the presently claimed invention does not require expensive phosphorous containing monomers in order to achieve a better hiding/opacifying efficacy.
4. The aqueous polymer dispersion of the presently claimed invention provides a good stability of the coating compositions and does not tend to form grit.
5. The waterborne coating composition comprising the latex of the presently claimed invention as a binder or co-binder provides excellent opacity to the coated surface.

### EMBODIMENTS

1. Use of an aqueous polymer latex as a binder or co-binder in a waterborne coating composition, which contains a titanium dioxide pigment,

wherein the aqueous polymer latex is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives;

2. The use according to embodiment 1 comprises 0.1 to 20 wt. % of at least one non-ionic monomer e), which is different from monomers a) to d).

3. The use according to any of embodiments 1 to 2, wherein the monomer c) is selected from the group consisting of acrylic acid and methacrylic acid.

4. The use according to any of embodiments 1 to 3, wherein the monomer c) is present in an amount in the range of ≥0.5 wt. % to ≤2.0 wt. %.

5. The use according to any of embodiments 1 to 4, wherein the meth acrylamide derivative is selected from the group consisting of N-methyl acrylamide, N-ethyl acrylamide, N-propyl acrylamide, N-isopropyl acrylamide, N-butyl acrylamide, N-methyl meth acrylamide, N-ethyl meth acrylamide, N-propyl meth acrylamide, N-isopropyl meth acrylamide and N-butyl meth acrylamide.

6. The use according to any of embodiments 1 to 5, wherein the monomer d) is present in an amount in the range of ≥0.5 wt. % to ≤2.0 wt. %.

7. The use according to any of embodiments 1 to 6, wherein the monomer a) and b) together in the range of 90.0 to 99.8 wt. %, based on the total weight of the monomers together.

8. The use according to any of embodiments 1 to 7, wherein the monomer composition M comprises
a) ≥40 wt. % to ≤79 wt. % tert-butyl acrylate
b) ≥20 wt. % to ≤59 wt. % n-butyl acrylate;
c) ≥0.5 wt. % to ≤1.5 wt. % acrylic acid; and
d) ≥0.5 wt. % to ≤1.5 wt. % acrylamide, with proviso a) and b) together in the range of 90 to 99.0 wt %.

9. An aqueous coating composition comprising:

i) at least one an aqueous polymer latex as a binder or co-binder,
wherein the aqueous polymer latex is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives; and
   ii) a titanium dioxide pigment.

10. An aqueous polymer latex which is obtained by polymerizing a monomer composition M by radical emulsion polymerization, wherein the monomer composition M comprises:
a) ≥40.0 wt. % to ≤79.8 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.

11. The aqueous polymer latex according to embodiment 10 comprises 0.1 to 20 wt. % of at least one non-ionic monomer e), which is different from monomers a) to d).

12. The aqueous polymer latex according to any of embodiments 10 to 11, wherein the monomer c) is selected from the group consisting of acrylic acid and methacrylic acid.

13. The aqueous polymer latex according to any of embodiments 10 to 12, wherein the monomer c) is present in an amount in the range of ≥0.5 wt. % to ≤2.0 wt. %.

14. The aqueous polymer latex according to any of embodiments 10 to 13, wherein the meth acrylamide derivative is selected from the group consisting of N-methyl acrylamide, N-ethyl acrylamide, N-propyl acrylamide, N-isopropyl acrylamide, N-butyl acrylamide, N-methyl meth acrylamide, N-ethyl meth acrylamide, N-propyl meth acrylamide, N-isopropyl meth acrylamide and N-butyl meth acrylamide.

15. The aqueous polymer latex according to any of embodiments 10 to 14, wherein the monomer d) is present in an amount in the range of ≥0.5 wt. % to ≤2.0 wt. %.

16. The use according to any of embodiments 10 to 15, wherein the monomer a) and b) together in the range of 90 to 99.8 wt. %, based on the total weight of the monomers together.

17. The aqueous polymer latex according to any of embodiments 10 to 18, wherein the monomer composition M comprises

a) ≥40 wt. % to ≤79 wt. % tert-butyl acrylate
b) ≥20 wt. % to ≤59 wt. % n-butyl acrylate;
c) ≥0.5 wt. % to ≤1.5 wt. % acrylic acid; and
d) ≥0.5 wt. % to ≤1.5 wt. % acrylamide,
with proviso the monomer a) and b) together in the range of 90.0 to 99.0 wt. %, based on the total weight of the monomers together.

While the presently claimed invention has been described in terms of its specific embodiments, certain modifications and equivalents will be apparent to those skilled in the art and are intended to be included within the scope of the presently claimed invention

The presently claimed invention is illustrated in detail by non-restrictive working examples which follow. More particularly, the test methods specified hereinafter are part of the general disclosure of the application and are not restricted to the specific working examples.

### EXAMPLES

Materials (provide remaining data)

| Common name/IUPAC | | Available |
|---|---|---|
| Name | Commercial name | from |
| Methyl methacrylate | Methyl methacrylate | BASF SE |
| t-Butyl acrylate | t-Butyl acrylate | BASF SE |
| Butyl acrylate | Butyl acrylate | BASF SE |
| Acrylic acid | Acrylic acid | BASE SE |
| Acrylamide | Acrylamide | BASF SE |
| polystyrene seed dispersion | polystyrene seed dispersion | BASF SE |
| Alkyldiphenyloxide | Dowfax ® 2A1 | Dow |
| Disulfonate | | Chemicals |
| C₁₃H₂₇O(CH2CH2O)xH | Lutensol ® TO 82 | BASF SE |
| sodium persulfate | sodium persulfate | Sigma Aldrich |
| t-butylhydroperoxide | t-butylhydroperoxide | BASF SE |
| Sodium | Rongalit ® C | Brueggemann |
| hydroxymethanesulfinate | | |
| Hydrophobically modified | Aquaflow ® XLS-525 | Ashland |
| polyether | | |
| Polysiloxanes and | BYK-024 | BYK |
| hydrophobic solids in | | |
| polyglycol | | |
| Polyacrylate ammonium | Ecodis ™ P90 | Coatex Arkema |
| salt | | |
| quaternary ammonium | Acticide ® | Thor GmbH |
| compounds | | |
| Titanium Dioxide | Kronos 2190 | Kronos |
| | | Worldwide, Inc |
| Opacifying calcium | Omyacoat ® 850-OG | Omya AG |
| carbonate | | |
| polysiloxanes and | BYK-093 | BYK |
| hydrophobic solids in | | |
| polyglycol | | |
| Hydrophobically modified | Aquaflow ® NHS-300 | Ashland |
| polyether | | |
| Coalescent | Coasol ® 290 Plus | Chemoxy |
| | | International |
| silicone defoamer | Foamstar ® SI2210 | BASF SE |
| Hydrophobically modified | Dispex ® CX4320 | BASF SE |
| polycarboxylate dispersant | | |
| High shear polyurethane | Rheovis ® PU1340 | BASF SE |
| thickener | | |
| TiO2 white pigment | Tiona ® 595 | Cristal |
| Calcium carbonate filler | Omyacarb ® 5GU | Omya AG |
| Coalescent | Texanol ® | Eastman |

### Methods

Tg: The glass transition temperature is measured by means of differential scanning calorimetry in accordance with ASTM D 3418-08. For conditioning, the polymers are poured out, dried over-night, then dried at 120° C. in a vacuum drying cabinet for 1 h. At measurement, the sample is heated to 150° C., cooled rapidly, and then measured on heating at 20° C./min up to 150° C. The value reported is the mid point temperature.

Average particle diameter: The weight-average particle diameter is measured by HDC (Hydrodynamic Chromatography fractionation). HDC measurements are carried out using a PL-PSDA particle size distribution analyzer (Polymer Laboratories, Inc.), by injecting a small amount of sample into an aqueous eluent containing an emulsifier, resulting in a concentration of approx. 0.5 WI and pumping the resulting mixture through a glass capillary tube of approx. 15 mm diameter packed with polystyrene spheres. As determined by their hydrodynamic diameter, smaller particles can sterically access regions of slower flow in capillaries, such that on average the smaller particles experience slower elution flow. The fractionation can be finally monitored using e.g. an UV-de-tector which measured the extinction at a fixed wavelength of 254 nm.

Solid contents: The solids content was determined by drying the sample and measuring its dry weight. Therefore, a solids content device Satorius MA 45 was used with constant weight program. A sample of 1.5 g was prepared in a tared small aluminum pan with glass fiber pad and covered with a cap. The drying program “120° C. Automatic” is started. The glass fiber pad is pre-dried with the same program. Every sample solids content is calculated by a double determina-tion.

Opacity Testing:

Test 1

On a Leneta card, the paints were applied with 3 different wet film thicknesses (50 μm, 100 μm and 150 μm) and subsequently dried for 24 h at 23° C. and 50% relative humidity.

The contrast ratio (Rb/Rw) was determined spectrophotometrically as the ratio of reflected light from the coating over the black portions (Rb) and the white portions (Rw) of the card expressed as a percentage. The contrast ratio indicates the capability of the coating to hide the black surface and thus indicates the opacity/hiding power of the coating.

Test 2

Spreading rates were determined by applying the guidelines in IS06504-3 at a 98% contrast ratio.

### Comparative example 1: Methyl methacrylate (46 wt %)/Butyl acrylate (52 wt %)/Acrylic acid (1 wt %)/Acrylamide (1 wt %)

Feed 1: 1345.2 g deionized water, 64.7 g Dowfax® 2A1 (45 wt %), 72.8 g Lutensol® TO 82 (20 wt %), 24.3 g acrylic acid, 48.5 g acrylamide (50 wt %), 1261.0 g butyl acrylate and 1115.5 g methyl methacrylate.

Feed 2: 69.3 g aqueous sodium persulfate solution (7 wt %).

Feed 3: 24.3 g aqueous t-butylhydroperoxide solution (10 wt %).

Feed 4: 21.8 g aqueous Rongalit® C solution (10 wt %).

Process: Deionized water (844.6 g) and polystyrene seed dispersion (95.5 g, 33 wt %, particle diameter: 30 nm) were charged to a reactor equipped with stirrer, temperature control, nitrogen inlet and multiple injection possibilities. The pH of the above mixture was maintained >3 using 12.1 g of an aqueous buffer solution (20 wt %). The reaction mixture was purged with nitrogen and heated to 85° C. At 85° C. feed 2 (17.3 g) was charged. After 5 min, feed 1 and remaining feed 2 were added in 180 min. The reaction mixture is post-polymerized at 85° C. for 30 min. Then feed 3 and feed 4 were added over a period of 60 min. After completion of the polymerization the reaction mixture was cooled down to ambient temperature and neutralized with sodium hydroxide to pH 8-9.

Tg (dried dispersion): 14° C.,

Average particle diameter: 124 nm,

Solid contents: 51.0 wt %.

### Example 2: t-Butyl acrylate (67 wt %)/Butyl acrylate (31 wt %)/Acrylic acid (1 wt %)/Acrylamide (1 wt %)

Feed 1: 1345.2 g deionized water, 64.7 g Dowfax® 2A1 (45 wt %), 72.8 g Lutensol® TO 82 (20 wt %), 24.3 g acrylic acid, 48.5 g acrylamide (50 wt %), 751.8 g butyl acrylate, 1624.8 g t-butyl acrylate.

Feed 2: 69.3 g aqueous sodium persulfate solution (7 wt %).

Feed 3: 24.3 g aqueous t-butylhydroperoxide solution (10 wt %).

Feed 4: 21.8 g aqueous Rongalit® C solution (10 wt %).

Process: Deionized water (844.6 g) and polystyrene seed dispersion (95.5 g, 33 wt %, particle diameter: 30 nm) were charged to a reactor equipped with stirrer, temperature control, nitrogen inlet and multiple injection possibilities. The pH of the above mixture was maintained >3 using 12.1 g of an aqueous buffer solution (20 wt %). The reaction mixture was purged with nitrogen and heated to 85° C. At 85° C. feed 2 (17.3 g) was charged. After 5 min, feed 1 and remaining feed 2 were added in 180 min. The reaction mixture is post-polymerized at 85° C. for 30 min. Then feed 3 and feed 4 were added over a period of 60 min. After completion of the polymerization the reaction mixture was cooled down to ambient temperature and neutralized with sodium hydroxide to pH 8-9.

Tg (dried dispersion): 15° C.

Average particle diameter: 123 nm

Solid contents: 50.8 wt %

### Example 3: t-Butyl methacrylate (47 wt %)/Butyl acrylate (51 wt %)/Acrylic acid (1 wt %)/Acrylamide (1 wt %)

Feed 1: 1345.2 g deionized water, 64.7 g Dowfax® 2A1 (45 wt %), 72.8 g Lutensol® TO 82 (20 wt %), 24.3 g acrylic acid, 48.5 g acrylamide (50 wt %), 1236.8 g butyl acrylate, 1139.8 g t-butyl methacrylate.

Feed 2: 69.3 g aqueous sodium persulfate solution (7 wt %).

Feed 3: 24.3 g aqueous t-butylhydroperoxide solution (10 wt %).

Feed 4: 21.8 g aqueous Rongalit® C solution (10 wt %).

Process: The process is similar to example 2.

Tg (dried dispersion): 15° C.

Average particle diameter: 125 nm

Solid contents: 50.3 wt %

Formulation of the Paints

### Comparative Example 4

100 g deionized water, 5 g Aquaflow® XLS-525 (Ashland) associative thickener, 4 g BYK-024 defoamer, 4 g Ecodis® P90 dispersant (Coatex Arkema) and 2 g Acticide® biozide (Thor GmbH) are mixed at low shear rate.

150 g Kronos 2190 pigment is dispersed with 500 to 2000 rpm for 5 min. 150 g Omyacoat 850-OG filler is dispersed with 4000 rpm for 10 min.

3 g BYK-093 defoamer, 20 g Aquaflow NHS-300 (Ashland) associative thickener, 9.2 g Coasol 290 Plus (Chemoxy) coalescing agent, 127.04 g deionized water and 425.76 g polymer binder from comparative example 1 are mixed with 1000 rpm for 10 min. to obtain the aqueous coating composition.

### Example 5

100 g deionized water, 5 g Aquaflow® XLS-525 (Ashland) associative thickener, 4 g BYK-024 defoamer, 4 g Ecodis® P90 dispersant (Coatex® Arkema) and 2 g Acticide biozide (Thor GmbH) are mixed at low shear rate.

150 g Kronos 2190 pigment is dispersed with 500 to 2000 rpm for 5 min. 150 g Omyacoat 850-OG filler is dispersed with 4000 rpm for 10 min.

3 g BYK-093 defoamer, 20 g Aquaflow NHS-300 (Ashland) associative thickener, 9.2 g Coasol 290 Plus (Chemoxy) coalescing agent, 125.36 g deionized water and 427.44 g polymer binder from Example 2 are mixed with 1000 rpm for 10 min. to obtain the aqueous coating composition.

### Example 6

100 g deionized water, 5 g Aquaflow® XLS-525 (Ashland) associative thickener, 4 g BYK-024 defoamer, 4 g Ecodis® P90 dispersant (Coatex® Arkema) and 2 g Acticide biozide (Thor GmbH) are mixed at low shear rate.

150 g Kronos 2190 pigment is dispersed with 500 to 2000 rpm for 5 min. 150 g Omyacoat 850-OG filler is dispersed with 4000 rpm for 10 min.

3 g BYK-093 defoamer, 20 g Aquaflow NHS-300 (Ashland) associative thickener, 9.2 g Coasol 290 Plus (Chemoxy) coalescing agent, 121.10 g deionized water and 431.69 g polymer binder from Example 3 are mixed with 1000 rpm for 10 min. to obtain the aqueous coating composition.

### Comparative Example 7

80.0 g of deionized water, 5.0 g of Foamstar SI2210 (silicone defoamer from BASF SE), 10.0 g of Dispex CX4320 (dispersant from BASF SE) and 16.0 g of Rheovis PU1340 (associative poly-urethane thickener from BASF SE) are added in a vessel and stirred using a Dissolver at 500 rpm for 5 min. To this mixture the following powder materials are added portion wise while the stirrer rate is increased to 2000 rpm: 160.0 g of Tiona 595, 50.0 g of Finntalc M15 and 55.0 g of Om-yacarb 5GU. After all material has been added, stirring is continued for another 20 minutes. After this period the stirrer speed is lowered to 1000 rpm. Then 15.0 g of Texanol (coalescent of East-man), 450.1 g of the comparative binder from comparative example 1, 1.0 g of Foamstar SI2210 and topped up to a total of 1000.0 g of formulated paint with 156.9 g of DI-water.

### Example 8

80.0 g of deionized water, 5.0 g of Foamstar SI2210 (silicone defoamer from BASF SE), 10.0 g of Dispex CX4320 (dispersant from BASF SE) and 16.0 g of Rheovis PU1340 (associative poly-urethane thickener from BASF SE) are added in a vessel and stirred using a Dissolver at 500 rpm for 5 min. To this mixture the following powder materials are added portion wise while the stirrer rate is increased to 2000 rpm: 160.0 g of Tiona 595, 50.0 g of Finntalc M15 and 55.0 g of Om-yacarb 5GU. After all material has been added, stirring is continued for another 20 minutes. After this period the stirrer speed is lowered to 1000 rpm. Then 15.0 g of Texanol (coalescent of East-man), 451.0 g of the binder from example 2, 1.0 g of Foamstar SI2210 and topped up to a total of 1000.0 g of formulated paint with 156.0 g of DI-water.

### Example 9

80.0 g of deionized water, 5.0 g of Foamstar SI2210 (silicone defoamer from BASF SE), 10.0 g of Dispex CX4320 (dispersant from BASF SE) and 16.0 g of Rheovis PU1340 (associative poly-urethane thickener from BASF SE) are added in a vessel and stirred using a Dissolver at 500 rpm for 5 min. To this mixture the following powder materials are added portion wise while the stirrer rate is increased to 2000 rpm: 160.0 g of Tiona 595, 50.0 g of Finntalc M15 and 55.0 g of Om-yacarb 5GU. After all material has been added, stirring is continued for another 20 minutes. After this period the stirrer speed is lowered to 1000 rpm. Then 15.0 g of Texanol (coalescent of East-man), 452.8 g of the binder from example 3, 1.0 g of Foamstar SI2210 and topped up to a total of 1000.0 g of formulated paint with 154.2 g of DI-water.

Test 1 (as Mentioned on Page 36)

On a Leneta card, the paints from Example 4-6 were applied with 3 different wet film thicknesses (50 μm, 100 μm and 150 μm) and subsequently dried for 24 h at 23° C. and 50% relative humidity.

The contrast ratio (Rb/Rw) was determined spectrophotometrically as the ratio of reflected light from the dried coating over the black portions (Rb) and the white portions (Rw) of the card expressed as a percentage. The contrast ratio indicates the capability of the coating to hide the black surface and thus indicates the opacity (hiding power) of the coating.

TABLE 1
Opacity test according to Test 1

| | % contrast ratio of dried coating | | |
|---|---|---|---|
| Paint | 50 μm (wet film | 100 μm (wet film | 150 μm (wet film |
| formulation | thickness) | thickness) | thickness) |
| Comparative | 96.5 | 96.8 | 97.9 |
| Example 4 | | | |
| Example 5 | 97.0 | 98.0 | 99.1 |
| Example 6 | 98.0 | 98.8 | 98.9 |

TABLE 2
Spreading rates according to ISO6504-3 at a 98% contrast ratio

| Paint formulation | yield with 98% opacity (m²/L) |
|---|---|
| Comparative Example 7 | 6.1 |
| Example 8 | 6.4 |
| Example 9 | 6.7 |

When comparing the examples 4 to 6 on table 1 and the examples 7 to 9 on table 2, it is evident that the coating that is prepared according to the presently claimed invention shows a superior contrast ratio/opacity/hiding power compared to the comparative examples. It is also evident that the coating containing a polymer binder comprising a monomer of formula (I) provides excellent opacity to the coated surface with less quantity of the aqueous coating composition.

1.-17. (canceled)

18. A waterborne coating composition comprising a titanium dioxide pigment and a binder or co-binder,
wherein the binder or co-binder is an aqueous polymer latex obtained by polymerizing a monomer composition M by radical emulsion polymerization, wherein the monomer composition M comprises:
a) ≥40.0 wt. % to ≤80 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.

19. The waterborne coating composition according to claim 18, wherein the monomer composition comprises 0.1 to 20 wt. % of at least one non-ionic monomer e), which is different from monomers a) to d).

20. The waterborne coating composition according to claim 18, wherein the monomer c) is selected from the group consisting of acrylic acid and methacrylic acid.

21. The waterborne coating composition according to claim 18, wherein the monomer c) is present in an amount in the range of ≥0.5 wt. % to ≤2.0 wt. %.

22. The waterborne coating composition according to claim 18, wherein the meth acrylamide derivative is selected from the group consisting of N-methyl acrylamide, N-ethyl acrylamide, N-propyl acrylamide, N-isopropyl acrylamide, N-butyl acrylamide, N-methyl meth acrylamide, N-ethyl meth acrylamide, N-propyl meth acrylamide, N-isopropyl meth acrylamide and N-butyl meth acrylamide.

23. The waterborne coating composition according to claim 18, wherein the monomer d) is present in an amount in the range of ≥0.5 wt. % to ≤2.0 wt. %.

24. The waterborne coating composition according to claim 18, wherein the monomer a) and b) together in the range of 90.0 to 99.8 wt. %, based on the total weight of the monomers together.

25. The waterborne coating composition according to claim 18, wherein the monomer composition M comprises
a) ≥40.0 wt. % to ≤80 wt. % of t-butyl acrylate or t-butyl methacrylate;
b) ≥20 wt. % to ≤59 wt. % of n-butyl acrylate,
c) ≥0.5 wt. % to ≤1.5 wt. % acrylic acid; and
d) ≥0.5 wt. % to ≤1.5 wt. % acrylamide,
with proviso a) and b) together in the range of 90 to 99.8 wt. %, based on total weight of the monomer together.

26. An aqueous coating composition comprising:
i) at least one an aqueous polymer latex as a binder or co-binder,
wherein the aqueous polymer latex is obtained by polymerizing a monomer composition M by radical emulsion polymerization, wherein the monomer composition M comprises:
a) ≥40.0 wt. % to ≤80 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives; and
ii) a titanium dioxide pigment.

27. An aqueous polymer latex which is obtained by polymerizing a monomer composition M by radical emulsion polymerization, wherein the monomer composition M comprises:
a) ≥40.0 wt. % to ≤80 wt. % of t-butyl acrylate or t-butyl methacrylate;
b) ≥20 wt. % to ≤59.8 wt. % of n-butyl acrylate,
c) ≥0.1 wt. % to ≤3.0 wt. % of at least one mono-ethylenically unsaturated carboxylic acid having 3 to 6 carbon atoms;
d) ≥0.1 wt. % to ≤3.0 wt. % acrylamide and/or meth acrylamide derivatives.

28. The aqueous polymer latex according to claim 27 comprises 0.1 to 20 wt. % of at least one non-ionic monomer e), which is different from monomers a) to d).

29. The aqueous polymer latex according to claim 27, wherein the monomer c) is selected from the group consisting of acrylic acid and methacrylic acid.

30. The aqueous polymer latex according to claim 27, wherein the monomer c) is present in an amount in the range of ≥0.5 wt. % to ≤2.0 wt. %.

31. The aqueous polymer latex according to claim 27, wherein the meth acrylamide derivative is selected from the group consisting of N-methyl acrylamide, N-ethyl acrylamide, N-propyl acrylamide, N-isopropyl acrylamide, N-butyl acrylamide, N-methyl meth acrylamide, N-ethyl meth acrylamide, N-propyl meth acrylamide, N-isopropyl meth acrylamide and N-butyl meth acrylamide.

32. The aqueous polymer latex according to claim 27, wherein the monomer d) is present in an amount in the range of ≥0.5 wt. % to ≤2.0 wt. %.

33. The use according to claim 27, wherein the monomer a) and b) together in the range of 90.0 to 99.8 wt. %, based on the total weight of the monomers together.

34. The aqueous polymer latex according to claim 27, wherein the monomer composition M comprises
a) ≥40.0 wt. % to ≤80 wt. % of t-butyl acrylate or t-butyl methacrylate;
b) ≥20 wt. % to ≤59.8 wt. % of n-butyl acrylate,
c) ≥0.5 wt. % to ≤1.5 wt. % acrylic acid; and
d) ≥0.5 wt. % to ≤1.5 wt. % acrylamide,
with proviso that the monomer a) and b) together in the range of 90.0 to 99.8 wt. %, based on the total weight of the monomers together.
